(19) United States
(12) Patent Application Publication
(10) Pub. No.: US 2006/0040148 A1
(43) Pub. Date: Feb. 23, 2006

(54) Method of treating composite plates

(75) Inventors: Richard H. Blunk, Macomb Township, MI (US); Tao Xie, Troy, MI (US); Mahmoud H. Abd Elhamid, Grosse Pointe Woods, MI (US); Youssef M. Mikhail, Sterling Heights, MI (US); Gayatri Vyas, Rochester Hills, MI (US); Daniel J. Lisi, Eastpointe, MI (US)

Correspondence Address: Cary W. Brooks;General Motors Corporation Legal Staff, 300 Renaissance Center, MC482-C23-B21, PO Box 300, Detroit, MI, 48265-3000, US

(73) Assignee: GM Global Technology Operations, Inc., Detroit, MI (US)

(21) Appl. No.: 11/206,597

(22) Filed: Aug. 18, 2005

Related U.S. Application Data
(60) Provisional application No. 60/602,754, filed on Aug. 19, 2004.

(51) Int. Cl. H01M 8/00; B23H 3/00

(52) U.S. Cl. 429/12; 427/430.1; 205/640

(57) ABSTRACT

Methods and systems for enhancing water management capabilities of a fuel cell system are described. The surface of a composite bipolar plate is chemically treated, for example with an oxidizer, to create a hydrophilic surface. The chemical treatment can include immersing the composite plate in an acid bath to acid etch the surface of the composite plate. Additionally, anodic roughening can also be utilized prior to placing the composite plate in the acid bath.

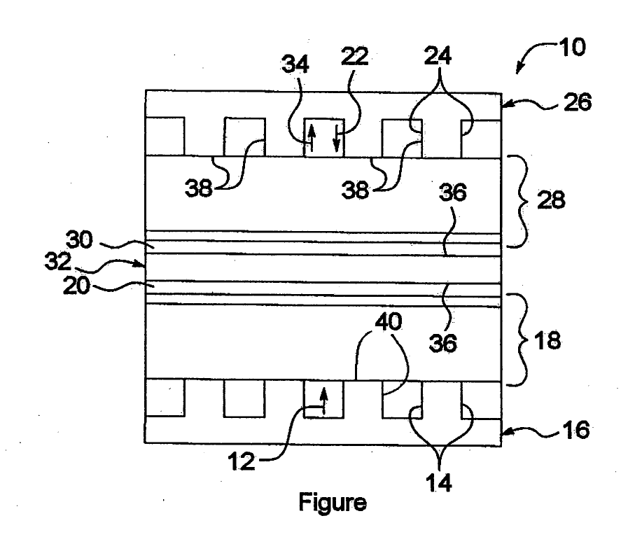

### CROSS REFERENCE TO RELATED APPLICATION

The instant application claims priority to U.S. Provisional Patent Application Ser. No. 60/602,754, filed Aug. 19, 2004, the entire specification of which is expressly incorporated herein by reference.

### FIELD OF THE INVENTION

The present invention generally relates to the treatment of composite fuel cell elements or plates for improved water management. More specifically, the present invention relates to increasing the surface hydrophilicity of a composite fuel cell plate using a chemical oxidation treatment for enhanced water management.

### BACKGROUND OF THE INVENTION

Fuel cells include three components: a cathode, an anode, and an electrolyte that is sandwiched between the cathode and the anode and passes only protons. Each electrode is coated on one side by a catalyst. In operation, the catalyst on the anode splits hydrogen into electrons and protons. The electrons are distributed as electric current from the anode, through a drive motor and then to the cathode, where as the protons migrate from the anode, through the electrolyte to the cathode. The catalyst on the cathode combines the protons with electrons returning from the drive motor and oxygen from the air to form water. Individual fuel cells can be stacked together in a series to generate increasing larger quantities of electricity.

In a Polymer-Electrolyte-Membrane (PEM) fuel cell, a polymer electrode membrane serves as the electrolyte between a cathode and an anode. The polymer electrode membrane currently being used in fuel cell applications requires a certain level of humidity to facilitate proton conductivity. Therefore, maintaining the proper level of humidity in the membrane, through humidity-water management, is desirable for proper functioning of the fuel cell. Irreversible damage to the fuel cell can occur if the membrane dries out.

In order to prevent leakage of the hydrogen gas and oxygen gas supplied to the electrodes and prevent mixing of the gases, a gas sealing material and gaskets are arranged on the periphery of the electrodes, with the polymer electrolyte membrane sandwiched therebetween. The sealing material and gaskets are assembled into a single part together with the electrodes and polymer electrolyte membrane to form a membrane and electrode assembly (MEA). Disposed outside of the MEA, are conductive separator plates for mechanically securing the MEA and electrically connecting adjacent MEAs in series. A portion of the separator plate, which is disposed in contact with the MEA, is provided with a gas passage for supplying hydrogen or oxygen fuel gas to the electrode surface and removing generated water.

The presence of liquid water in automotive fuel cells is unavoidable because appreciable quantities of water are generated as a by-product of the electrochemical reactions during fuel cell operation. Furthermore, saturation of the fuel cell membranes with water can result from rapid changes in temperature, relative humidity, and operating and shutdown conditions. Excessive membrane hydration may result in flooding, excessive swelling of the membranes and the formation of differential pressure gradients across the fuel cell stack.

Cell performance is influenced by the formation of liquid water or by dehydration of the ionic exchange membrane. Water management and the reactant distribution have a major impact on the performance and durability of fuel cells. Cell degradation with mass transport losses due to poor water management still remains a concern for automotive applications. Long exposure of the membrane to water can also cause irreversible material degradation. Water management strategies such as pressure drop, temperature gradients and counter flow operations have been implemented and been found to reduce mass transport to some extent especially at high current densities. Good water management, however, is still needed for performance and durability of a fuel cell stack.

At least one attempt to create hydrophilic composite fuel cell plates is to plasma treat the surfaces of the composite plates. These plasma treated surfaces of the composite plates exhibit high hydrophilicity and, in turn, reduce low-power stability when tested in a fuel cell stack. However, plasma treated hydrophilic composite fuel cell surfaces have been found, in some instances to be unstable, and therefore relatively short-lived in a fuel cell stack environment.

Accordingly, there exists a need for new and improved fuel cell composite plates that exhibit improved water management characteristics.

### SUMMARY OF THE INVENTION

In accordance with a first embodiment of the present invention, a method for forming a hydrophilic surface on a fuel cell element is provided, comprising: (1) providing a fuel cell element having a surface formed thereon; and (2) chemically treating the surface of the fuel cell element to create a hydrophilic surface thereon.

In accordance with an alternate embodiment of the present invention, a method for forming a hydrophilic surface on a fuel cell element is provided, comprising: (1) providing a fuel cell element having a surface formed thereon; (2) roughening the surface of the fuel cell element; and (3) chemically treating the surface of the fuel cell element to create a hydrophilic surface thereon.

In accordance with an alternate embodiment of the present invention, a fuel cell system is provided, comprising a fuel cell element having a surface formed thereon, wherein the surface of the fuel cell element has been chemically treated to create a hydrophilic surface thereon.

### BRIEF DESCRIPTION OF THE DRAWINGS

Advantages of the present invention will be more fully appreciated from the detailed description when considered in connection with accompanying drawings of presently preferred embodiments which are given by way of illustration only and are not limiting wherein:

The FIGURE is a schematic view of a fuel cell system, in accordance with the general teachings of the present invention.

### DETAILED DESCRIPTION OF THE PREFERRED EMBODIMENTS

The following description of the preferred embodiment(s) is merely exemplary in nature and is in no way intended to limit the invention, its application, or uses.

A fuel cell system is generally shown at 10 in the FIGURE. During operation of the fuel cell system 10, hydrogen gas 12 flows through the flow field channels 14 of a bipolar plate generally indicated at 16 and diffuses through the gas diffusion medium 18 to the anode 20. In like manner, oxygen 22 flows through the flow field channels 24 of the bipolar plate generally indicated at 26 and diffuses through the gas diffusion medium 28 to the cathode 30. At the anode 20, the hydrogen 12 is split into electrons and protons. The electrons are distributed as electrical current from the anode 20, through a drive motor (not shown) and then to the cathode 30. The protons migrate from the anode 20, through the PEM generally indicated at 32 to the cathode 30. At the cathode 30, the protons are combined with electrons returning from the drive motor (not shown) and oxygen 22 to form water 34. The water vapor and/or condensed water droplets 34 diffuses from the cathode 30 through the gas diffusion medium 28, into the field flow channels 24 of the bipolar plate 26 and is discharged from the fuel cell stack 10.

During transit of the water vapor/droplets 34 from the cathode side of the MEA 30 to the bipolar plate 26 and beyond, the hydrophilic or hydrophobic bipolar plate surfaces 38, 40, respectively, of the bipolar plates 16, 26, respectively, aid in water management.

Thus, it is well known that in a fuel cell stack at the cathode side, the fuel cell generates water in the catalyst layer. The water must leave the electrode. Typically, the water leaves the electrode through the many channels 24 of the element or bipolar plate 26. Typically, air passes through the channels and pushes the water through the channels 24. A problem that arises is that the water creates a slug in the channels 24 and air cannot get to the electrodes. When this occurs, the catalyst layer near the water slug will not work. When a water slug forms, the catalyst layer near the slug becomes ineffective. This condition is sometimes referred to as flooding of the fuel cell. The result of flooding is a voltage drop that creates a low voltage cell in the stack.

A similar phenomenon holds true on the anode side of the cell. On the anode side of the cell, hydrogen can push the water through the channels 14 of the element or bipolar plate 16.

Often times, when a voltage drop occurs, the voltage drop continues to worsen. When one of the channels 14, 24, respectively, in the plate 16, 26, respectively, becomes clogged, the oxygen or hydrogen flow rate passing through the other channels in other cells within the same stack increases. Eventually, the cell with insufficient gas flow to force water out through its channels saturates with water and may flood. Because the stack is in series, eventually the whole fuel cell stack may flood with water and shut down. Accordingly, it is desirable to improve the water management properties of the bipolar plates to enhance stack performance and durability and eliminate low performance cells.

One attempt to solve the problem has been to increase the velocity of the gas, air on one side or hydrogen on the other, to force the water to move through the channels. However, this is an inefficient method for clearing the water from the channels and is not cost effective.

According to one embodiment of the present invention, the surfaces 38, 40, respectively, of the fuel cell elements or bipolar plates 16, 26, respectively, are modified to improve water management. More specifically, the surfaces 38, 40, respectively, of the bipolar plates 16, 26, respectively, are modified to create hydrophilic surfaces. The bipolar plates 16, 26, respectively, are preferably composite plates comprising a polymer and graphite/carbon fibers. One such composite plate is comprised of a bulk molding compound material and is readily commercially available from Bulk Molding Compound, Inc. (Perrysburg Ohio).

Hydrophilic surfaces on fuel cell bipolar plates are desirable for improving water management and thus increasing fuel cell efficiency. Without being bound to a particular theory of the operation of the present invention, it is believed that a hydrophilic surface on the composite plate helps wick water through the channels 14, 24, respectively, thus preventing water slug formation in the channels 14, 24, respectively.

According to one embodiment of the present invention, a chemical oxidation treatment is used to increase both the surface roughness and surface energy of composite plates, making the surface more hydrophilic so that water droplets can wick into the channels and be efficiently removed from the flow field channels at low gas velocities. The chemical treatment oxidizes the carbon in both the polymer and graphite regions on the surface of the plate, which in turn, modifies the surface chemistry by generating more hydrophilic polar groups. In addition, the chemical treatment can oxidize and etch away composite material at the surface, which increases the surface roughness, and, in turn, increases surface hydrophilicity. It is well known (e.g., via Wenzel's equation) that surface roughness affects water contact angles (e.g., water spreading), i.e., a semi-hydrophilic (e.g., <90 degrees)/semi-hydrophobic (e.g., >90 degrees) becomes more hydrophilic/hydrophobic as roughness increases.

The use of the chemical treatment both modifies the surface chemistry and roughens the surface of composite plates. In one example, a chemically treated composite plate sample was analyzed to measure the surface roughness using WYKO Surface Profilers from WYKO Corp. (Tucson, Ariz.). WYKO surface profiler systems are non-contact optical profilers that use optical interferometric techniques to measure the topographic features of smooth and rough surfaces.

The chemically treated composite plate showed a dynamic contact angle in the range of 23 plus or minus 5 degrees, advancing 37 degrees, receding 21 degrees. This relatively low value is thought to be created by the combination of two levels of roughness, at the nano-scale of roughness and the micro-scale of roughness.

The chemical treatment used to make the sample comprised the steps of:

(1) submerging the bonded composite plate into chromic acid/sulfuric acid bath at 50 to 110 degrees C. for between 2 to 30 minutes. The bath contained 490 g chromic oxide, 800 ml water and 160 ml of sulfuric acid. Other oxidants/processes can also be used, such as but not limited to chromic anhydride/tetrachloroethane, chromic acid/acetic acid, potassium dichromate/sulfuric acid, cycloalkylchromate, potassium permanganate, sodium hypochlorite, and chlorosulfonation;

(2) Neutralize the hexavalent chromium (i.e., Cr⁺⁶) to Cr⁺³ using ethylenediamine (e.g., 20 percent in water); and

(3) Rinse the plates in de-ionized water to remove the excess chromic acid.

In addition to the chemical treatment set forth above, the composite plate surface could also be initially roughened using an anodic roughening technique and then acid etched to increase the wettablility of the surface of the composite plate. This enables the polymer skin to be removed more easily to reduce the acid etching time and/or provides a more roughened surface. The anodic roughening preferably comprises the steps of:

(1) placing the boded composite plates in a 0.025M sulfuric acid solution for 5 to 30 seconds; and

(2) applying a potential (e.g., 2V, 2 A).

During this process, oxygen evolves on the composite surface while the skin layer is etched away.

The roughness on the composite plate surface created using the above method is such that a water droplet has nowhere to adhere. Thus, the water droplet spreads over the surface. Although the hydrophilic surface due to polar groups may eventually lose effectiveness under hot and dry stack conditions, the roughened surface should remain relatively wet during fuel cell operation due to its higher surface area and porosity. A wet film on the roughened surface causes the next water droplet from the gas diffusion medium to quickly spread out along the channel surface, enabling the water to be removed at low gas velocity.

Accordingly, the present invention provides a hydrophilic surface that improves water management in the fuel stack. Further, the hydrophilic surface enhances the low power stability of the stacks. Also, the roughening of the surface further improves fuel cell performance and improves the durability of the fuel cell stacks.

The invention has been described in an illustrative manner, and it is to be understood that terminology which has been used is intended to be in the nature of words of description, rather than of limitation. Many modifications and variations of the present invention in light of the above teachings.

What is claimed is:

1. A method for forming a hydrophilic surface on a fuel cell element, comprising:
providing a fuel cell element having a surface formed thereon; and
chemically treating the surface of the fuel cell element to create a hydrophilic surface thereon.

2. The invention according to claim 1, wherein the fuel cell element comprises a bipolar plate.

3. The invention according to claim 1, wherein the chemical treatment includes exposing the fuel cell element in a material selected from the group consisting of chromic acid, sulfuric acid, chromic oxide, chromic anhydride, tetrachloroethane, acetic acid, potassium dichromate, cycloalkylchromate, potassium permanganate, sodium hypochlorite, chlorosulfonic acid, and combinations thereof.

4. The invention according to claim 1, wherein the chemical treatment comprises submerging the fuel cell element in an acidic bath.

5. The invention according to claim 4, further comprising anodic roughening of the fuel cell element prior to placing the fuel cell element in the acidic bath.

6. The invention according to claim 5, wherein the anodic roughening of the fuel cell element comprises:
immersing the fuel cell element in an acidic solution; and
applying an electric current to the acidic solution.

7. The invention according to claim 1, wherein the chemical treatment comprises oxidizing the fuel cell element.

8. The invention according to claim 7, wherein the oxidation modifies the surface of the fuel cell element to form polar and/or hydrophilic groups thereon.

9. The invention according to claim 7, wherein the oxidation modifies the surface of the fuel cell element to impart roughness to the surface of the fuel cell element.

10. The invention according to claim 1, further comprising anodic roughening of the fuel cell element prior to chemically treating the fuel cell element.

11. The invention according to claim 10, wherein the anodic roughening of the fuel cell element comprises:
immersing the fuel cell element in an acidic solution; and
applying an electric current to the acidic solution.

12. A method for forming a hydrophilic surface on a fuel cell element, comprising:
providing a fuel cell element having a surface formed thereon;
roughening the surface of the fuel cell element; and
chemically treating the surface of the fuel cell element to create a hydrophilic surface thereon.

13. The invention according to claim 12, wherein the fuel cell element comprises a bipolar plate.

14. The invention according to claim 12, wherein the chemical treatment comprises submerging the fuel cell element in an acidic bath.

15. The invention according to claim 12, wherein the chemical treatment includes submerging the fuel cell element in a material selected from the group consisting of chromic acid, sulfuric acid, chromic oxide, chromic anhydride, tetrachloroethane, acetic acid, potassium dichromate, cycloalkylchromate, potassium permanganate, sodium hypochlorite, chlorosulfonic acid, and combinations thereof.

16. The invention according to claim 12, wherein the roughening of the fuel cell element comprises:
immersing the fuel cell element in an acidic solution; and
applying an electric current to the acidic solution.

17. The invention according to claim 12, wherein the chemical treatment comprises oxidizing the fuel cell element.

18. The invention according to claim 17, wherein the oxidation modifies the surface of the fuel cell element to form polar and/or hydrophilic groups thereon.

19. The invention according to claim 17, wherein the oxidation modifies the surface of the fuel cell element to impart roughness to the surface of the fuel cell element.

20. A fuel cell system, comprising:
a fuel cell element having a surface formed thereon;
wherein the surface of the fuel cell element has been chemically treated to create a hydrophilic surface thereon.

21. The invention according to claim 20, wherein the fuel cell element comprises a bipolar plate.

22. The invention according to claim 20, wherein the chemical treatment includes submerging the fuel cell element in a material selected from the group consisting of chromic acid, sulfuric acid, chromic oxide, chromic anhydride, tetrachloroethane, acetic acid, potassium dichromate, cycloalkylchromate, potassium permanganate, sodium hypochlorite, chlorosulfonic acid, and combinations thereof.

23. The invention according to claim 20, wherein the chemical treatment comprises submerging the fuel cell element in an acidic bath.

24. The invention according to claim 23, wherein the fuel cell element has been anodically roughened prior to placement of the fuel cell element in the acidic bath.

25. The invention according to claim 24, wherein the anodic roughening of the fuel cell element comprises:
immersing the fuel cell element in an acidic solution; and
applying an electric current to the acidic solution.

26. The invention according to claim 20, wherein the chemical treatment comprises oxidizing the fuel cell element.

27. The invention according to claim 26, wherein the oxidation modifies the surface of the fuel cell element to form polar and/or hydrophilic groups thereon.

28. The invention according to claim 26, wherein the oxidation modifies the surface of the fuel cell element to impart roughness to the surface of the fuel cell element.

29. The invention according to claim 20, wherein the surface of the fuel cell element has been anodically roughened prior to chemical treatment of the fuel cell element.

30. The invention according to claim 29, wherein the anodic roughening of the fuel cell element comprises:
immersing the fuel cell element in an acidic solution; and
applying an electric current to the acidic solution.
